(19) United States
(12) Patent Application Publication
(10) Pub. No.: US 2011/0165363 A1
(43) Pub. Date: Jul. 7, 2011

(54) FOAMED PLASTICS MATERIAL PANEL

(75) Inventors: Thomas Wolf, Hochdorf (CH); Moritz Pieper, Ruschlikon (CH)

(73) Assignee: 3A TECHNOLOGY & MANAGEMENT LTD., Neuhausen am Rheinfall (CH)

(21) Appl. No.: 13/056,461

(22) PCT Filed: Jul. 4, 2009
(86) PCT No.: PCT/EP2009/004839

§ 371 Date: Mar. 8, 2011

(30) Foreign Application Priority Data
Jul. 30, 2008 (EP) 08405190.3

(51) Int. Cl. B32B 3/18; B32B 5/18; B32B 37/02; B32B 37/06; B32B 37/04; B32B 37/14; B32B 38/10; B32B 38/00

(52) U.S. Cl. 428/47; 428/44; 156/78

(57) ABSTRACT

Planar structural element, as a portion of a foam block, the foam block being made of a foamed plastics material, containing a plurality of stacked foam bodies and/or foam bodies made of body segments, which are arranged next to one another in a plane and connected to one another to form foam bodies and which have flat weld seams at their abutting faces, and the foam bodies being welded to one another at their abutting faces with the formation of flat weld seams to form the foam block. The weld seams between the foam bodies are interrupted by recesses at a spacing from one another. The planar structural element is preferably used as the core or core layer in sandwich composites, for example in rotor vanes of wind power plants.

The present invention relates to a planar structural element, as a portion of a foam block, the foam block being made of a foamed plastics material, containing a plurality of stacked foam bodies and/or foam bodies made of body segments, which are arranged next to one another in a plane and connected to one another to form foam bodies and which have weld seams on their abutting faces, and the foam bodies are welded to one another at their abutting faces with the formation of flat weld seams to form a foam block, as well as a method for producing a planar structural element of this type and the use thereof.

It is known to use panels made of a foamed thermoplastic plastics material as core layers in sandwich composites or composite components. Foamed plastics material panels of this type may, for example, be produced by means of an extrusion method. The structural loading capacity, for example the compressive strength at right angles to the extrusion direction, of core layers which are produced by means of extrusion methods cannot always meet the requirements set in all cases. Composite components with the core layers mentioned often cannot therefore meet all the requirements as structural components for demanding requirements.

However, for demanding applications, such as, for example, structural components in transportation, sandwich composites are required which have a high degree of strength, in particular compressive strength and rigidity, and the core materials of which have high shear strength and rigidity. In order to achieve these properties, stronger and often thicker outer layers are used, for example. This generally leads to an undesired increase in the specific weight of the sandwich composites. In addition, the compressive strength of such sandwich composites cannot be increased as desired by the use of thicker outer layers.

It is therefore desirable for not only the outer layers but also the core layers to have an increased compressive and shear strength, without, however, having to forfeit the advantage of the lower density of foam bodies.

This measure would, on the one hand, allow the production of sandwich composites with improved strength and rigidity properties without a noteworthy increase in the specific weight. On the other hand, the use of core layers with an increased rigidity and strength would also allow the use of thinner outer layers.

Thus, foamed plastics material panels are known which have improved strength owing to the specific configuration of the core layer.

EP 1 536 944, for example, describes the planar structural elements made of foamed thermoplastic plastics materials, wherein planar structural elements are produced from a plurality of body segments by welding and the structural elements are stacked by welding the mutually contacting side faces to form blocks. The planar weld seams form a plastics material intermediate layer, which has few pores or is pore-free, between the body segments and the structural elements. The structural elements which are separated from the block transverse to the weld seams have a net-like reinforcing web structure in plan view, which is formed by the weld seams. The structural elements may form the core or the intermediate layer of a sandwich composite, a multi-layer composite or a moulded body.

During the production of, for example, sandwich composite elements, the core is covered on one or both sides with outer layers and the outer layers are connected to the core. For non-separable connection of the outer layer and core, an adhesive is arranged between their surfaces facing one another. If composite components are produced, a core made of a core material is placed, for example, in a hollow mould and, in individual cases, reinforcing materials, such as, for example, fibres, for example in the form of mats, knitted fabrics, webs, woven fabrics etc., made of glass, carbon, polymers, natural fibres etc., are arranged between the mould and core. The space provided between the core and mould is filled with a resin, such as a polyester resin, an epoxy resin, a vinyl ester resin etc., the resin and optionally the reinforcement material forming the outer layer completely or partially surrounding the core. In particular, to form the outer layer, the core and, in individual cases the reinforcement materials, are placed in a hollow mould which can be evacuated, a vacuum is applied and the resin is injected in. In order on the one hand to keep the total weight of the composite component low, and on the other hand to obtain high stability of the composite component, the resin quantities have to be used in a controlled manner. It is advantageous for the gap size between the hollow mould and the core, and therefore the thickness of the outer layer, to be kept as small as possible. Small gap sizes in turn make the resin distribution more difficult, in particular with large-area composite components, during the injection method.

The object of the present invention is to propose a planar, in particular panel-shaped, structural element which is suitable as the core material and for core layers, as well as to produce cores of sandwich composite elements or composite components. The planar structural element is to contain a foam with a closed-cell structure and nevertheless allow a favourable resin distribution in the hollow mould, as the core. The object also comprises an economical method for producing the planar structural element mentioned. The planar structural element should also be unmixed as far as possible.

The object is achieved according to the invention in that the weld seams are interrupted by recesses at a spacing from one another.

The weld seams are preferably interrupted between the foam materials by recesses at a spacing from one another.

The planar structural element is preferably completely made of plastics material. The foam bodies are, for example, panel-shaped moulded bodies, produced in one piece by means of an extrusion foaming method, or produced from a plurality of extrusion-foamed body segments welded to one another, with the formation of flat weld seams. The foam bodies may be stacked and welded to one another at the contact faces, or at their mutually abutting side faces, with the formation of flat weld seams. The flat weld seams between the foam bodies form a plastics material intermediate layer, which has few pores or is pore-free, in the form of a web structure having a reinforcing effect in plan view. The flat weld seams between the body segments and the foam bodies form a plastics material intermediate layer, which has few pores or is pore-free, in the form of a web or net structure having a reinforcing effect in plan view.

The planar structural element is, for example, panel-shaped, preferably formed as a panel element, in particular as a cuboid panel element, in individual cases, as a moulded body with an irregular outer shape.

The foam bodies, or the body segments, in the planar structural element may be produced by means of extrusion and the weld seam faces and the recesses lie, in particular, in the extrusion direction of the foam bodies.

The planar structural element according to the invention expediently consists of or contains thermoplastic plastics materials. The thermoplastic plastics materials are preferably polystyrene (PS), acrylonitrile/butadiene/styrene graft copolymers (ABS), polyethylene (PE), polypropylene (PP), polyvinyl chloride (PVC), polycarbonate (PC) and, in particular, polyethylene terephthalate (PET), polybutylene terephthalate, polyphenylene ether (PPE) or polyblends thereof, such as poly(phenylene ether)-polystyrene polyblend (PPE+PS), polyetherimides or styrene/acrylonitrile copolymers (SAN).

The structural element according to the invention is preferably unmixed, i.e. it preferably consists of a single plastics material. The unmixed nature may be advantageous during recycling. As the weld seams are formed from the respective thermoplastic plastics material, an application of adhesives, in particular adhesives of a different chemical nature than the foamed plastics material, to connect the body segments and foam bodies, can be avoided.

The specific weight of a structural element according to the invention is, for example more than 20 kg/m³, preferably more than 40 kg/m³ and, in particular, more than 50 kg/m³ and, for example, less than 500 kg/m³ and preferably less than 350 kg/m³. Specific weights of structural elements according to the invention are preferably between 50 kg/m³ and 320 kg/m³. The pore size of the foams is, for example, in the range from 100 to 1,000 μm. The foams are, in particular, closed-cell foams, i.e. have predominantly or exclusively closed pores. The open cell nature to ASTM D1056 may, for example, be less than 10%, in particular less than 4%.

The weld seams are preferably formed by melted and, after the joining process, rehardened thermoplastic plastics material of the body segments or foam bodies. The body segments or foam bodies, in particular at the joined side faces, have flat melting and rehardening zones here.

In the planar structural element, the thickness of the weld seams and/or the wall thickness of the recesses is advantageously established in such a way that the web structure or net structure of the weld seams and/or the walls of the recesses improve the strength of the structural element, for example with regard to the surface pressures, the shear and bending stress and the elongation at break under shear stress. This means that the weld seams are not only joining points between two body segments, but, at the same time, may also be reinforcement or strengthening webs between two body segments made of foam. Furthermore, the weld seams also bring about a reinforcement of the planar structural element with regard to shear and bending stress and improved elongation at break under shear stress. The strength or thickness of the weld seams is therefore not only configured with regard to the criterion of a stable connection seam but also with regard to the criterion of an effective reinforcement or strengthening structure.

The thickness of the melting and rehardening zone of the side wall faces, which form the weld seams, is therefore selected in such a way that the planar structural element, in particular, has high compressive strength with regard to surface pressures and increased elongation at break under shear stress.

The body segments, or foam bodies, are preferably joined together and welded without gaps, i.e. without the formation of cavities. The body segments therefore preferably have a moulded cross-section allowing a gap-free joining together of the body segments.

The body segments, or foam bodies, may also be joined together or glued together in a non-stressed configuration using an adhesive to form a planar structural element.

In the planar structural elements, the individual body segments and the individual foam bodies, in the plan view of the planar structural element, may have a polygonal form, expediently an octagonal, hexagonal or triangular form, preferably a quadrangular form and, in particular, a rectangular or square form. In other words, the body segments, or the foam bodies, in a plan view of a structural element, for example, may have a square, rectangular, hexagonal or triangular outline, which outlines the so-called outer faces of the body segments, or of the foam bodies.

The size of the body segments and the foam bodies may vary depending on the rigidity or compressive strength of the structural element to be achieved.

As each of the aforementioned geometries and sizes of the body segments and of the foam bodies leads to planar structural elements with different properties, the geometry and size of the body segments is determined primarily on the basis of the specific requirements of the structural element.

The body segments are present, for example, in the form of cubes or parallelepiped, in particular in the form of strands with a square or cuboid cross-section. Body segments in the form of strands with a square or cuboid cross-section may, for example, be arranged lying next to one another in one layer and welded flat, the longitudinally shaped weld connections forming a web structure and the foam bodies being formed in this manner. Foam bodies may be arranged stacked welded flat to one another, with the transversely lying weld connection forming a web structure. A foam block is formed by means of the welding, with web-shaped weld connections, for example with a net structure with crossing weld seams. If the body segments are arranged offset with respect to one another in two foam bodies located one above the other, the weld connections form continuous transverse weld seams and longitudinal weld seams which are offset with respect to one another in the manner of a brick wall.

Body segments which are present in a cuboid shape may, for example, (in a plan view of the structural element) have a square or rectangular cross-section with a side length (x) of 20 to 400 mm, preferably from 30 to 300 mm, in particular from 50 to 150 mm, a width (y) of 20 to 2,000 mm, preferably from 30 to 1,000 mm, in particular from 50 to 800 mm. A rectangular foam body may, for example, be produced from two or more body segments. As the welding can be continued as desired per se in both directions, foam blocks of almost any width can be produced. A side edge length in the x-direction of 20 to 400 mm and in the y-direction of 40 to 2,000 mm appear to be sensible (in a plan view of the structural elements, see also FIG. 1). The height h is in the extrusion direction. Accordingly, the latter is non-critical, as it is generally a continuous process. The extruded body segments, or, in individual cases, directly extruded foam bodies, are generally cut to length to 30 mm to 2,000 mm, expediently from 100 to 1,800 mm and, in particular, to 400 to 1,200 mm. Thus, foam blocks with edge lengths of, for example, up to 2,000 mm, are produced.

The individual body segments may, in a plan view of a planar structural element, furthermore also have a curved, for example concave or convex outline or outline portions. The body segments may also be configured in the manner of a composite brick, i.e. the body segments are formed in such a way that the individual body segments are rigidly joined to one another. The body segments of a structural element according to the invention are also preferably congruent with one another. The side faces of the body segments are moreover preferably perpendicular to the outer faces in the case of panel-shaped structural elements. The foam bodies formed from the body segments which are welded together may be stacked and the touching side faces of these foam bodies may be welded flat to one another. A foam block according to a first embodiment is thus formed. According to a second embodiment, the foam bodies may also be produced as such, in one piece, directly, for example by extrusion foaming. The weld seams are then missing through the length of the foam body. The foam bodies may be stacked and the touching side faces of these foam bodies may be welded to one another flat. A foam block is also formed here. It is also possible to stack alternately as desired the two types of foam bodies and weld them into foam blocks.

In the planar-shaped structural element, the foam bodies or body segments which are produced by means of extrusion method and the weld seam faces can be arranged in the extrusion direction of the foam bodies and the recesses lie at an angle of 0° or greater and expediently from 0 to 90° to the extrusion direction. The angle may, for example, be 0° to 90°, with regard to an axis running parallel to the longitudinal side and in the extrusion direction, of the foam body, or a body segment. If the recesses are not arranged in the extrusion direction and parallel to the longitudinal side, the recesses are expediently arranged at an angle of about 1° to 60°, preferably 15° to 60°, in particular 30° to 45° and quite particularly preferably 45°.

The invention also relates to a method for producing a planar structural element, containing a plurality of body segments made of a foamed plastics material arranged next to one another in a plane and connected to one another.

The method according to the invention for producing a planar structural element (10), containing a plurality of stacked foam bodies (7) and/or foam bodies (7) made of body segments (11), which are arranged next to one another in a plane and connected to one another, made from a foamed plastics material, the structural element (10) being completely made of plastics material and the body segments (11) being welded to one another at their abutting faces with the formation of flat weld seams (12, 13), implemented by the following steps:

a. producing closed-cell foam bodies (7) by an extrusion and foaming process or producing body segments (11) by an extrusion and foaming process, followed by welding together the longitudinal sides of the body segments (11) by flat partial melting of the side faces (8) of the body segments (11) to be connected and subsequent joining and rehardening to form foam bodies (7) with the formation of flat weld seams (32), the flat weld seams (32) being present as plastics material intermediate layers, which have few pores or are pore-free;
b. welding together the longitudinal sides of the foam bodies (7) by flat partial melting of the longitudinal sides (43, 44) of the foam bodies (7) to be connected and subsequent joining and rehardening to form a foam block (5) with the formation of flat weld seams (33), the flat weld seams (33) being present as plastics material intermediate layers, which have few pores or are pore-free;
c. dividing the foam block (5) into individual planar structural elements (30), in particular foam panels, transverse to the longitudinal direction of the foam bodies (7),
wherein the flat weld seams (32, 33), in a plan view of the planar structural element (30), form a web or net structure having a reinforcing effect. The extrusion direction is, in particular, designated the longitudinal direction.

The foam bodies (7) or body segments (11) are preferably produced by means of an extrusion process. The foam bodies or body segments preferably have an orientation of the material drawn in the extrusion direction. In this case, in particular, polymer chains have undergone a drawing in the extrusion direction owing to the extrusion. The material drawing brings about an improvement in the mechanical properties, in particular the compressive strength, in the drawing direction.

The foam bodies or body segments also preferably have a cell structure or cell arrangement which is oriented in the extrusion direction. The oriented cell structures of the foam body contribute here to an increase in the compressive strength of the structural element.

In one possible configuration of the invention, the rod or pillar-shaped body segments or the foam bodies may be obtained from a prefabricated foam block, i.e. cut or sawn. The foam block mentioned is in this case preferably produced by means of an extrusion method.

According to a specific embodiment variant of the invention, the production of the foam bodies or the body segments takes place by means of extrusion methods. The body segments may, for example, be expanded plastics material strands. The strands being produced may be combined to produce foam bodies or body segments. The strands may be combined directly after leaving the extrusion mould by the expanding of the individual strands. In this case, contact occurs between the respective adjacent strands, and a growing together or adhesion or welding thereof takes place with the formation of the body segment, in individual cases, the foam body. The respective body is in this case present in the form of a closed package of strands.

The strands are preferably substantially parallel to one another and are arranged in the longitudinal direction, i.e. extrusion direction of the body segment or foam body. The production method may be such that the individual strands in the body segment or foam body remain visible or are combined or melted or welded to form a single structure, in which the individual strands are only just hinted at or are no longer recognisable at all. The strands are preferably densely packed in such a way that the individual strands abut one another, touching over the whole area, without forming intermediate spaces.

The strands are expediently produced by an extrusion tool, which, for example, is present as a moulding plate, the extrusion tool containing a large number of adjacent openings, through which the polymer is extruded in a strand shape. Said openings may have a polygonal cross-section such as, a rectangular, square or hexagonal cross-section. The foamed strands may have an edge length of, for example, 3 to 50 mm, in particular 4 to 20 mm.

A further moulding tool reflecting the outer contour of the body segment which is to be produced or the foam body can be connected downstream of the extrusion mould to produce the strands, the package of strands being guided into said moulding tool after leaving the extrusion mould, so the body segment or the foam body adopts the cross-sectional form of the moulding tool. The above-described production method can be used to produce body segments, which already have the desired cross-sectional form and size. To directly produce foam bodies, the extrusion mould may be a moulding tool reflecting the outer contour of the foam body which is to be produced.

Furthermore, foam bodies with a cross-sectional size which is greater than the cross-section of the required foam bodies, can be produced using the above-described production methods, so in subsequent processing steps the extruded foam body can be cut to size into individual rod or pillar-shaped body segments or foam bodies.

In a preferred configuration of the foam bodies or body segments which are produced according to the above methods, the orientation of the individual strands of the body segments or foam bodies is substantially perpendicular to the outer faces of the flat structural elements formed from body segments. In this case, the compressive strength caused by the orientation of the strands, in the longitudinal direction of the strands, i.e. in the extrusion direction, is preferably greater than in other directions.

The body segments and foam bodies may be produced by extruding and foaming by means of physical and chemical foaming agents. In a preferred embodiment, the foam bodies, in particular body segments or foam bodies produced by an extrusion method are physically foamed by means of a gaseous foaming agent, such as CO₂. The foaming agent can be supplied directly into the extrusion device here. In the planar structural element, the body segments and the foam bodies have a drawing of the polymer structure oriented in the extrusion direction.

In a preferred configuration of the invention, the extruded foam bodies are welded on the longitudinal side, i.e. along their touching longitudinal sides, to form plastics material blocks. Planar, in particular panel-shaped, structural elements are then cut from these plastics material blocks transverse or perpendicular to the longitudinal sides of the foam bodies.

The cutting of the planar structural elements from the plastics material blocks can take place by means of a mechanical process, such as sawing, or by means of a physical process, such as a thermal cutting process.

The weld connection preferably takes place by means of flat partial melting of the side faces of the body segments to be connected and a subsequent joining thereof and hardening of the melting zones.

In a preferred embodiment variant, means are provided to control the partial melting process during the welding and allow the production of weld seams of a specific thickness or thickness range, the thickness range, in individual cases, being selected such that the web structure of the weld seams exerts a reinforcing effect on the planar structural element.

The welding process is expediently a thermoplastic welding. The weld connection can be produced by means of contact welding. The plastics material welding method which can be applied is heating element welding. The welding process can take place with or without additional materials. A further welding method is welding by radiation, it being possible to heat the surfaces to be welded without contact, for example, by radiation.

The planar structural elements can be produced according to the invention, for example, in that the foam bodies (7) are partially melted by means of a heating blade (40) with a structured surface with the production of groove-shaped indentations in the foam body (7) or in that foam bodies (7) structured by groove-shaped indentations on one or both sides are partially melted by means of a heating blade (40) with an unstructured surface or in that unstructured foam bodies (7) are firstly partially melted by means of a heating blade (40) with an unstructured surface and then by means of a matrix providing a structure and the partially melted side faces of the foam bodies (7) are joined with the formation of recesses (45) in the weld seam (33).

The method can be carried out, in particular, in such a way that, in each case, the longitudinal sides (43, 44) of two foam bodies (7, 7′) extending in the extrusion direction are heated on a heating blade (40), in particular being a panel with two heated side faces (41, 42), until the respectively heated surfaces of the longitudinal side (43, 44) of the foam bodies (7, 7′) soften or partially melt. In accordance with the supply of heat, the foamed thermoplastic plastics material softens or melts to such an extent that the cells located on the surface collapse and a thin skin of a molten mass forms. One or both side faces of the heating blade (40) have a structure (46, 47, 48). The structure (46, 47, 48) is embossed in the manner of a matrix in the thermoplastic plastics material. The treated foam bodies (7, 7′) are distanced from the heating blade (40) and the heating blade (40) is then removed. The two heated and, in individual cases, structured surfaces of the foam bodies (7, 7′) are brought into contact with one another in the heated state, in individual cases with pressure loading, the touching surfaces (43, 44) being welded to one another and hardening with cooling of the plastics material.

The surface of the heating blade may be coated or treated, completely or partially, to an adhesive strength that is as small as possible. This may be a Teflon coating or chromium coating or the surface may be a chromium or aluminium surface treated by polishing or glossing etc.

In a further embodiment of the method for producing a planar structural element according to the present invention, the partial melting of the longitudinal sides of the foam bodies can take place by means of a heating blade with unstructured surfaces or the partial melting can take place with a structured surface on one or both sides projecting in the manner of a comb, i.e. from the surface of the heating blade, such as a surface structured with profile rods, with the production of groove-shaped indentations in the foam body. A plurality of elongate indentations, for example in the form of grooves, channels or notches, can be additionally let into one or both surfaces of heating blades of this type, in one or else in both surfaces.

One or both of the effective surfaces of the heating blade may have elongate indentations, in the form, for example, of grooves, channels or notches. The elongate indentations advantageously extend in a regular sequence over the entire or a partial area of the effective surface of the heating blade. The elongate indentations may, for example, be a pattern of a sequence arranged over the effective surface of the heating blade, for example running in parallel, obliquely or diagonally with respect to a side edge, of parallel elongate indentations or a plurality of elongate elongations arranged obliquely or diagonally or crossing one another. The elongate indentations in the surface of the heating blade are ones, which, for example, have a depth of 1.0 to 10.0 mm, preferably from 3.0 to 6.0 mm, and a width of 1 to 100 mm, preferably from 10 to 30 mm, and which may be arranged at a mutual spacing of, for example, 10 to 100 mm, preferably from 20 to 40 mm.

In one embodiment of the method, the heating blade may have a structure on one or both surfaces. The structure may be formed by a plurality of profile rods arranged in parallel at a spacing. The profile rods advantageously extend over the entire height of the heating blade and are, for example, distributed over the entire width of one or both surfaces, preferably at identical spacings, on the surface. In the case of profile rods on the two surfaces, these may be located precisely opposite one another or may be offset with respect to one another.

If the profile rods are precisely opposite on the two surfaces of the heating blade, the structure thereof is embossed into the thermoplastic plastics material of the respective foamed bodies. When the two structured surfaces of the foam bodies are welded, the embossed structures oppose one another in a mirror-symmetrical manner and form a single large recess. If the profile rods oppose one another alternately on the two surfaces of the heating blade, the structure thereof is embossed into the thermoplastic plastics material of the respective foam bodies. When the two structured surfaces of the foam bodies are welded, the embossed structures oppose one another alternately and, relative to the above-described embodiment, form twice the number of small recesses. The structure is arranged on the heating blade in such a way that the recesses being produced on the foam body run in the same extrusion direction.

The structure on one or both sides of the heating blade may also be a pattern of profile rods arranged running obliquely or diagonally in parallel over the surface of the heating blade or profile rods arranged obliquely or diagonally crossing one another. In the case of profile rods on the two surfaces, these may oppose one another precisely or may be offset with respect to one another. With crossing profile rods, the profile rods, for example, form a lattice or waffle pattern or a grid structure on one or both surfaces of the heating blade (40) as a structure. The crossing profile rods, for example, form a lattice or waffle structure or a grid structure. The obliquely or diagonally running profile rods may run at any angle, in particular 0° to 90°, with respect to a side edge of the heating blade and the profile rods are, for example, arranged at an angle of about 1° to 60°, expediently of 15° to 60°, in particular of 30° to 45° and quite particularly preferably of 45°. Accordingly, owing to crossing profile rods, crossing recesses are provided in, for example, a lattice or waffle pattern or in a grid structure, between the foam bodies. Recesses which are produced by the obliquely or diagonally running profile rods in the foam body may be arranged at any angle, i.e. 0° to 90°, with respect to an axis running parallel to the longitudinal side and in the extrusion direction of the foam body. In other words, the recesses may, for example, be arranged at an angle of about 1° to 60°, expediently of 15° to 60°, in particular of 30° to 45° and quite particularly preferably of 45°. It is also possible to apply recesses which run in the axis parallel to the longitudinal side (0°) and further recesses which run at any other angle to the axis parallel to the longitudinal side, to the foam body.

The profile rods may, for example, have a semicircular, segment-shaped, U-shaped or V-shaped, truncated cone-shaped or polygonal cross-section, such as triangular, square or rectangular.

The heating blade which is generally guided in the linear direction out of the region between the heated surfaces of the longitudinal sides of the foam bodies and the heated longitudinal sides of the foam bodies are then brought into mutual contact. After the heating process, the heated, or heated and embossed foam bodies can be demoulded, the heating blade then removed and the heated side faces brought into mutual contact.

The method may, for example, be carried out in a different manner in such a way that the opposing longitudinal sides of two foam bodies, one of the two longitudinal sides of the foam bodies already being structured with grooves, channels or milled portions, are heated on a heating blade, in particular being a panel with two heated unstructured, smooth side faces, to such an extent that the surfaces of the foam bodies soften or partially melt. The heating blade is then removed and the two structured heated surfaces of the foam bodies are brought into mutual contact, in individual cases by pressure loading, the plastics material hardening with cooling. Grooves, channels or milled portions can be applied by cutting methods such as milling on the side faces of the foam bodies. It is also possible to provide the grooves or channels by thermal loading of the surfaces, such as embossing by means of a heated matrix or by structuring with energy-rich radiation, for example by laser. Grooves or channels may be applied by corresponding matrices during the extrusion process and foaming process on the foam body or body segment being produced. Thermal methods are preferred, as the closed-cell pores which are present are not torn and opened. Pores which are opened by cutting processes are less favourable, in individual cases, as resin may accumulate during the later processing to form structural components or composite panels etc., in the pore spaces. This can lead to higher specific densities of the foam bodies and to increased weight of the structural components or composite panels etc. The grooves, channels or milled portions may be arranged running spaced apart in parallel, in particular in the extrusion direction or form a pattern. The pattern can form grooves, channels or milled portions arranged running straight, obliquely or diagonally in parallel over the surface of the longitudinal side of the foam body or grooves, channels or milled portions arranged straight, obliquely or diagonally crossing one another. In the case of grooves, channels or milled portions at the two surfaces which are to be welded, the latter may oppose one another precisely or may be offset with respect to one another. In the case of crossing grooves, channels or milled portions, the latter, for example, form a lattice or waffle pattern or a grid structure. Accordingly, crossing recesses, in, for example, a lattice or waffle pattern or in a grid structure are provided between the foam bodies by crossing grooves, channels or milled portions. Recesses produced by the obliquely or diagonally running grooves, channels or milled portions in the foam body, may be arranged at any angle, i.e. 0° to 90°, with respect to an axis running parallel to the longitudinal side and in the extrusion direction of the foam body. In other words, the recesses may, for example, be arranged at an angle of about 1° to 60°, expediently of 15° to 60°, in particular of 30° to 45° and quite particularly preferably of 45°. It is also possible to provide recesses which run in the axis parallel to the longitudinal side (0°) and further recesses which run at any angle to the axis parallel to the longitudinal side on the foam body.

The method can, for example, be carried out in a different manner again in such a way that the opposing longitudinal sides of two foam bodies are heated on a heating blade, in particular being a panel with two heated unstructured, smooth side faces, to such an extent that the surfaces of the foam bodies melt or partially melt. The heating blade is then removed. Instead of the heating blade, a matrix, for example a comb-like matrix, is introduced between the heating surfaces of the foam bodies and the matrix and the foam bodies, in individual cases under pressure loading, are brought into mutual contact, with the plastics material welding and hardening with cooling and the matrix being then guided out of the melting or softening zone of the two foam bodies. To shape the recesses, the comb-like matrix may have a plurality of rod-like prongs oriented in parallel spaced apart on a straight line. The cross-section of the prongs, which may be rounded, round or polygonal, forms—like the mentioned profile rods—the cross-section of the recesses. The length of the prongs at least corresponds to the longitudinal side of the foam body which is to be structured. The recesses which are produced by the prongs run in the foam body, in particular in the extrusion direction.

The planar structural elements, compared to conventional foamed plastics material panels, for example, have a higher rigidity, a higher compressive strength and higher elongation at break under shear stress. These properties are at least partially based on the weld seams between the individual body segments or foam bodies. The weld seams form webs or a network of connections in the manner of a scaffold, the weld seams being present in the form of dense plastics material intermediate layers which have few pores or are pore-free. The scaffold of the web-like or net-like connections of the weld seams increases the compressive strength as the webs of the plastics material intermediate layer are substantially less compressible than the foam bodies themselves. If, for example, a surface pressure is exerted on the structural element according to the invention (for example in a sandwich composite, a surface pressure over the outer layers on the structural element in the function as a core layer), the compressive forces act primarily on the rigid web or net structure and not on the foam body itself. The increase in the rigidity of structural elements according to the invention also results from the scaffold-like structure of the weld seams, which lead to an increased torsional rigidity and flexural strength.

The walls of the recesses may form dense plastics material layers, which have few pores or are pore-free, on the planar structural elements according to the invention. The recesses, which generally penetrate the planar structural element in its entire thickness, the number and the thickness of the walls thereof, can lead to a further increase in the rigidity, the compressive strength and the elongation at break under shear stress of the planar structural element. If the recesses are produced with the welding of the foam bodies, the walls of the recesses, just like the weld connections, are expediently produced by melting and rehardening and are plastics material layers, which have few pores or are, in particular, pore-free. The cross-section of the recesses is, for example, an image or imprint of the shaping profile rod. The walls of the recess substantially consist of the thermoplastic plastics material of the cells of the foam, which have deformed during the heating process or collapsed and melted. The weld seams of the body segments, the weld seams of the foam bodies and the walls of the recesses are accordingly expediently formed on the planar structural element from the molten and rehardened plastics material.

The thickness or strength of the walls can be controlled by the action of pressure and heat. The recesses generally also pass through the entire thickness of the foam block and form tube or small tube-like openings. As the planar structural element is a part which is separated from the foam block transverse to the running direction of the recesses, the recesses are to be found correspondingly in form and number in the planar structural element.

The planar structural elements according to the present invention have, per square meter of outer face, at least 200, expediently at least 400, up to 60,000, and preferably up to 40,000, recesses. The surface of the planar structural element in which the recesses are arranged is called the outer face. On the planar structural element, the recesses have a diameter or a mean diameter or edge length of, for example, 0.2 to 10 mm, expediently of 1 to 5 mm and preferably 2 to 3 mm. The mutual spacing of the recesses in the respective weld seam may be, for example, 2 to 100 mm. The spacing between the recesses within the respective weld seam is preferably about 2 to 20 times, in particular 5 to 10 times, the diameter of the largest edge length of the recess.

The planar structural element, in particular, is a part separated from the foam block transverse to the running direction of the recesses. The height h of the planar structural element may, for example, be from 3 to 1000 mm, a height of 5 to 500 mm being expedient, from 10 to 400 mm being preferred and from 20 to 250 mm being particularly preferred.

The structural element according to the invention is used in composite components and sandwich composite elements, such as composite panels. Sandwich composite elements, such as sandwich composite panels, may have a core layer, in particular a structural element according to the invention and, arranged on one or both sides, outer layers or a covering. If the planar structural element according to the invention is used as a core layer in a sandwich composite panel, the structural element is expediently a panel element.

Composite components or moulded bodies contain, for example, an outer skin or outer layer and a core. The planar structural elements according to the invention are particularly preferably used as a core material or core layer in moulded bodies or composite components. For example, a structural element according to the invention is inserted as a core layer in a hollow mould with the formation of a gap space between the core and mould wall. In individual cases, reinforcement materials, such as fibres, for example as a woven fabric, as a web or knitted fabric etc., may be inserted in the gap. The resin is supplied by an injection or infusion method. The hollow mould may, for example, be evacuated and resin, such as, for example, a polyester resin, an epoxy resin or a vinyl ester resin, can be injected in a flowable form, into the hollow mould. The resin is distributed between the outer layer or outer skin and core layer and penetrates or flows through, in particular, the recesses in the planar structural element. The recesses accordingly have to be passable with respect to the resin. This achieves a uniform distribution of the resin within the gap space, the resin flowing through the core material supporting its uniform distribution in the entire mould cavity space. If the object is to increase the density of the composite component as a whole, or the structural element, as little as possible, the number and/or diameter, or the volume of the recesses, should be as small as possible. If, however, a structural reinforcement of the composite element is aimed for, the resin that has hardened or set remaining in the correspondingly voluminously formed and/or numerous recesses of the structural element is used for further reinforcement by increasing the rigidity, the compressive strength or the elongation at break under shear stress.

Sandwich composite elements with structural elements according to the invention as the core layer, despite their low weight, have high rigidity and excellent shear and compressive strength. Sandwich structures of this type are therefore suitable, in particular, for applications which require light but structurally highly loadable components. The outer layers may, for example, be rigid or flexible panels made of plastics material or fibre-reinforced plastics material, such as glass fibre-reinforced plastics material. Furthermore, the outer layers may also be panels or sheets made of metal, in particular of aluminium or an aluminium alloy. The outer layers are, in comparison to the core layer, preferably comparatively thin panels. Sandwich composite elements with structural elements according to the invention as the core layer may, for example, be used as construction elements in the building industry. Examples of such construction elements are walls, floors, ceilings, doors, intermediate walls, partitions or cladding elements. These may, for example, be sandwich composite elements for box bodies, loading bridges, walls, ceilings, doors, lids, claddings or parts thereof on lorries or railway wagons for goods transportation or walls, ceilings, floors, intermediate walls, cladding elements, doors, ceilings or parts thereof, on vehicles or for passenger transportation, such as buses, trams, railway wagons or on ships, such as passenger ships, ferries, pleasure steamers or boats.

Composite components with structural elements according to the invention as the core material are used inter alia in transportation on land (for example road or rail vehicle construction), on water (for example ship or boat construction, water sport equipment construction) or in the air (for example aircraft construction), but also, however, like the sandwich composite elements in sports articles for use on land, in water or in the air.

The composite components with structural elements according to the invention are preferably used as a core or core layers in rotor blades, to move fluids, in particular gases, such as air or as the core or core layers in rotor blades of wind power plants. The use of the structural elements according to the invention is particularly preferred as the core material in wind varies or rotor blades for wind power plants.

The invention will be described in more detail below by way of example and with reference to the accompanying drawings, in which:

FIG. 1 shows an exploded view of a sandwich composite with a structural element according to the invention as the core layer;

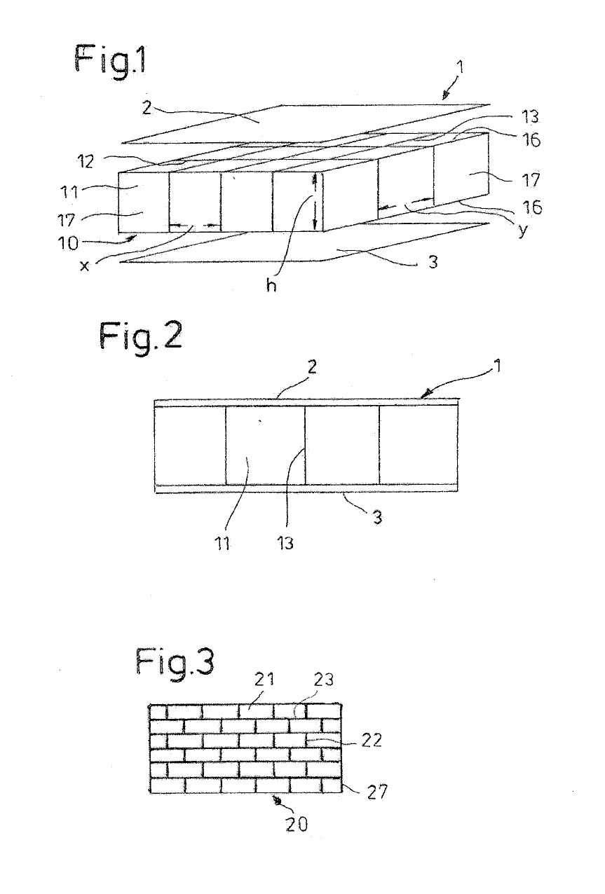

FIG. 2 shows a cross-section through a sandwich composite with a structural element according to the invention as the core layer;

FIG. 3 shows a plan view of a structural element according to the invention;

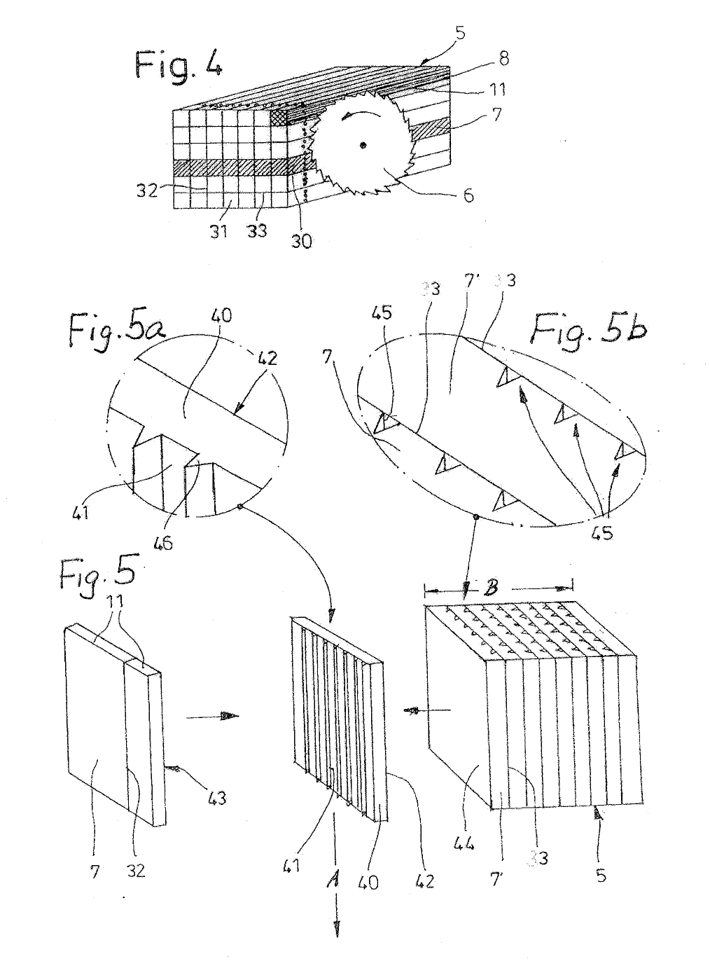

FIG. 4 shows a perspective view of a plastics material block for producing structural elements according to the invention;

FIG. 5 shows a perspective view of the joining of a foam block to produce structural elements according to the invention;

FIG. 6 shows a perspective view of sawing a plastics material block to form structural elements according to the invention;

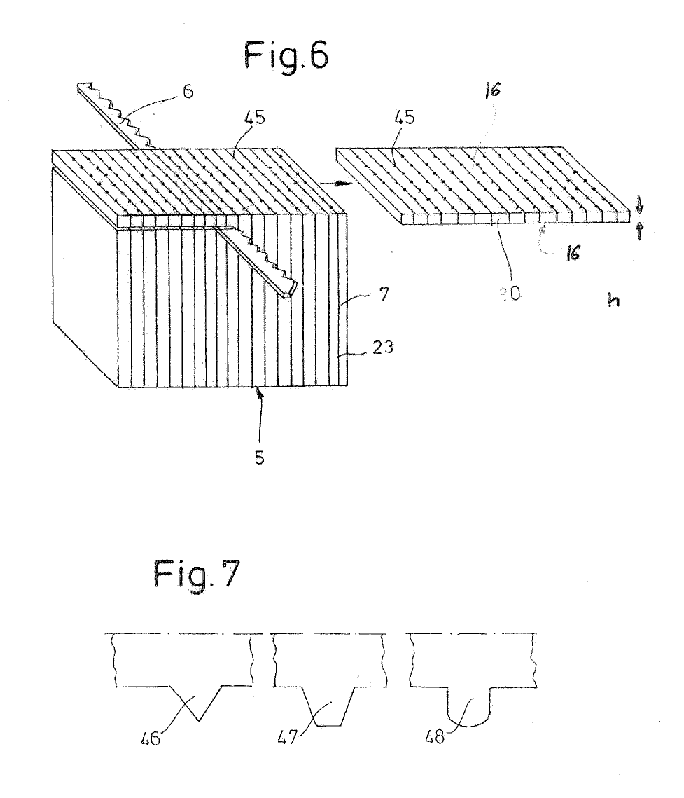

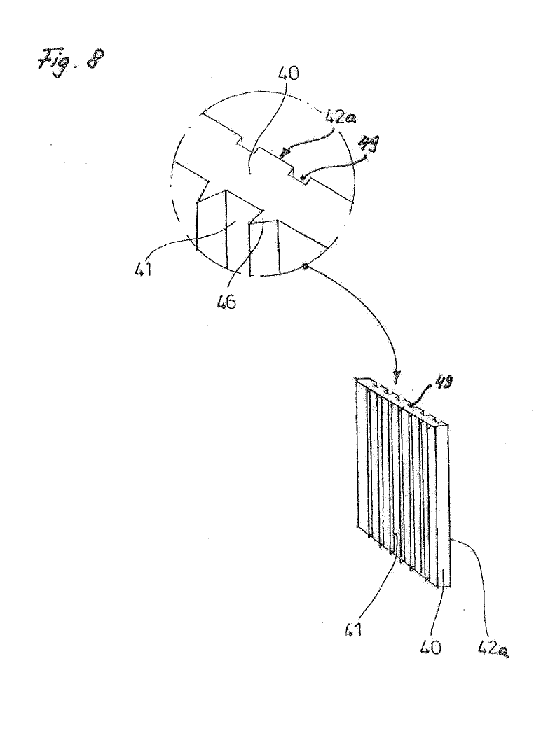

FIG. 7 shows a cross-section through examples of profile rods providing structure on heating blades;

FIG. 8 shows a view of a heating blade and a detail from it.

FIG. 1 shows a sandwich composite element 1 with a core layer made of a planar structural element 10 according to the invention, which is configured as a plastics material panel made of foamed body segments welded together. The plastics material panel 10 consists of cuboid body segments 11, which are connected to one another by means of flat weld connections formed by means of longitudinal 12 and transverse weld seams 13 at their touching side faces 17. The weld seams 12, 13 form here (in a plan view of the panel) a net-like, rigid web structure. An outer layer 2, 3 is in each case arranged on both sides of the core layer, on the outer faces 16 of the body segments 11. The outer layers 2, 3 may consist, for example, of plastics material panels, fibre-reinforced plastics material panels (for example glass fibre-reinforced thermosetting plastics or thermoplastics) or metal sheets, such as aluminium sheets. The recesses are not shown for improved clarity.

FIG. 2 shows a sandwich composite element 1 according to FIG. 1 in cross-section. The outer layers 2, 3 are connected to the core layer 11. The transverse weld seams 13 are visible.

FIG. 3 shows an embodiment of a structural element according to the invention in the form of a plastics material panel 20 made of foam bodies 27 stacked one above the other and welded to one another by the weld seams 23. The foam bodies are formed from body segments 21 which are arranged located next to one another and welded to one another by means of the weld seams 22.

The plastics material panel 20 according to FIG. 3 contains body segments 21 with a rectangular cross-section in the plan view of the panel. The body segments 21 according to FIG. 3 are arranged in a plane with several next to one another, the weld connections 22 between the body segments 11 forming webs. The body segments 21 arranged with several next to one another in a plane according to FIG. 3 form the foam bodies 27 in a plurality of layers stacked one above the other with weld connections 22 displaced with respect to one another, the weld connections forming a brick wall-like structure with continuous transverse weld seams 23 and longitudinal weld seams 22 offset with respect to one another.

FIG. 4 shows pillar-shaped or rod-shaped body segments 11, the body segments 11 (by way of example a single body, longitudinally hatched) being produced, for example, by extrusion, and formed foam bodies 7 (by way of example a single body, obliquely hatched), which, in turn, stacked and welded together, form the foam block 5. The individual body segments 11 are connected to one another by means of plastics material welding with the formation of longitudinal weld seams 32 along their longitudinal sides 8, to form the foam bodies 7. The foam bodies 7 are connected with the formation of the transverse weld seams 33 to form the foam block 5. By sawing 6 or thermal cutting (along the dotted line), the foam block 5 is divided into individual plastics material panels 30, the planar structural elements according to the invention.

FIG. 5 shows the joining of the foam block 5 by means of the heating blade 40. A foam block 5 under construction, made of a plurality of foam bodies which are already welded by means of the weld seams 33, with the foam body 7′ located on the outside, is guided in the arrow direction toward the heated heating blade 40 and, in particular, the surface 42, which is unstructured here. A foam body 7 is guided in the arrow direction onto the opposing side of the heating blade 40, onto the structured surface 41. The foam body 7 is manufactured here, by way of example, from two body segments 11, which are connected by a weld seam 32. The parts 5, 40, 7 are guided toward one another, preferably under a contact pressure, in such a way that a uniform heat transmission takes place and the structured surface 41 is impressed like a matrix into the surface 43 of the foam body 7. The thermoplastic plastics materials of the foam bodies 7, 7′ soften or melt on the surfaces 43, 44 under the action of heat of the heating blade 40. With a melt viscosity adequate for welding, the heating blade 40 between the two longitudinal sides of the foam bodies 7, 7′ is removed in the A-direction and the two longitudinal sides 7, 7′ guided toward one another and under at least slight contact pressure, the hot surfaces 43, 44 are welded and, after cooling, form a further non-separable weld seam 33. If not interrupted by the recesses 45, the foam bodies 7, 7′ are welded, in particular, over the entire area by means of the weld seams 33. The process is repeated until the desired length is reached in the direction B of the foam block 5.

By way of example, the detail in FIG. 5a of the heating blade 40 shows its unstructured surface 42 and the structured surface 41 provided with profile rods 46 providing the cross-sectionally triangular shape. The surface 41 is provided with a plurality of profile rods 46. The profile rods 46 extend, in particular, in parallel and in the movement direction of the heating blade 40. The profile rods 46 run at least over the entire height of the effective surface 41 of the heating blade 40. The spacing of the profile rods 46 depends on the number of desired recesses 45 and may, for example, be 2 to 100 mm. The length of the side edges of the presently triangular shape of the profile rods 46 may, for example, be 0.2 to 10 mm. In accordance with the shape and the number of profile rods 46, the recesses 45, with a triangular cross-section here, are formed between the two abutting foam bodies 7, 7′. FIG. 5b shows an enlarged detail from the foam block 5, with the two foam bodies 7, 7′ welded by means of the seams 33, and the formed recesses 45.

If the foam block 5 has reached its desired size by joining together the foam bodies 7 by means of the weld seams 33, the planar structural elements 10 according to the invention can be separated, as shown in FIG. 6, with a separating means, such as a saw 6, at the desired height h or thickness, which may be as desired, and particularly preferably may be 20 to 250 mm. The planar structural elements 10 are separated off transverse to the course of the recesses 45. The recesses 45 run through the entire foam block 5 and, accordingly completely, the height or thickness of the separated off structural element 10. The recesses 45, therefore in each case, end at the outer faces 16 of the structural element 10 and therefore form openings.

FIG. 7 shows various exemplary possible cross-sectional shapes of profile rods, such as a V-shape or triangular shape 46, a truncated cone shape 47 or a U-shape 48. The profile rods 46, 47 or 48 may, in a plurality, form the surface structure of one or both surfaces 41, 42 of the heating blade 40. It is also possible to form the same cross-sectional shapes in a negative form as grooves or channels in the foam bodies, such as to mill them in or form them in thermally and to weld together the grooved or embossed foam bodies. The shapes shown are not limiting.

An embodiment which has been changed relative to FIG. 5a with respect to the surface 42 is shown in FIG. 8. The heating blade 40 has a surface 42a provided with elongate indentations 49. The opposing surface 41 of the heating blade is provided with the profile rods 46 projecting from the surface 41 and providing a cross-sectionally triangular shape, for example. The surface 42a is provided with a plurality of elongate indentations 49 let in, such as milled in, into the surface 42a. The elongate indentations 49 extend, for example, in parallel and in the movement direction of the heating blade 40. The elongate indentations 49 advantageously extend over the entire height of the effective surface 42a of the heating blade 40. The position, arrangement and number of the elongate indentations 49 is independent of the position, arrangement and number of profile rods 46.

### LIST OF REFERENCE NUMERALS

1 sandwich composite element
2 outer layer
3 outer layer
5 foam block
6 saw
7, 27 foam body
8 longitudinal side of the body segment
10, 20, 30 plastics material panel, planar structural element
11, 21, 31 body segment
12, 22, 32 (longitudinal) weld seam
13, 23, 33 (transverse) weld seam
16 outer face
17 side face
40 heating blade
41 structured surface
42 unstructured surface
42a surface structured with grooves
43 longitudinal side of the foam body 7
44 longitudinal side of the foam body 7
45 recesses
46 shaping profile rod in V-shape
47 shaping profile rod in truncated cone shape
48 shaping profile rod in U-shape
49 elongate indentations in surface of the heating blade

1. A planar structural element, as a portion of a foam block, wherein the foam block is made of a foamed plastics material containing a plurality of stacked foam bodies and/or foam bodies made of body segments, which are arranged next to one another in a plane and connected to one another to form foam bodies and which have flat weld seams at their abutting faces, and the foam bodies are welded to one another at their abutting faces with the formation of flat weld seams to form the foam block, wherein the weld seams are interrupted by recesses at a spacing from one another.

2. A planar structural element according to claim 1, wherein the weld seams between the foam bodies are interrupted by recesses at a spacing from one another.

3. A planar structural element according to claim 1, wherein the flat weld seams form a plastics material intermediate layer, which has few pores or is pore-free, in the form of a web structure with a reinforcing effect in plan view and the recesses have walls, which have few pores or are pore-free.

4. A planar structural element according to claim 1, wherein the weld seams of the body segments, the weld seams of the foam bodies and the walls of the recesses are formed from the molten and rehardened thermoplastic plastics material.

5. A planar structural element according to claim 1, wherein the thickness of the weld seams, and/or the wall thickness of the recesses, is established in such a way that a net-like web structure of the weld seams and/or the walls of the recesses improves the strength of the structural element.

6. A planar structural element according to claim 1, wherein the foam bodies or the body segments are produced by means of extrusion, and the weld seam faces and the recesses lie in the extrusion direction of the foam bodies.

7. A planar structural element according to claim 1, wherein the foam bodies or the body segments are produced by means of extrusion, and the weld seam faces lie in the extrusion direction of the foam bodies, and the recesses, in relation to an axis running parallel to the longitudinal side of the foam bodies and in the extrusion direction, are arranged at an angle of 0° or greater.

8. A planar structural element according to claim 1, wherein the planar structural element has outer faces on both sides and, per square metre of outer face, has at least 200 recesses.

9. A planar structural element according to claim 1, wherein the recesses have a diameter or mean diameter or an edge length of 0.2 to 10 mm.

10. A planar structural element according to claim 1, wherein the mutual spacing between the recesses within the respective weld seam is 2 to 100 mm.

11. A planar structural element according to claim 1, wherein the spacing between the recesses within the respective weld seam is 2 to 20 times the diameter, the mean diameter or the largest edge length of the recess.

12. A planar structural element according to claim 1, wherein the individual body segments and the individual foam bodies, in the plan view of the planar structural element, have a polygonal shape.

13. A method for producing a planar structural element according to claim 1, containing a plurality of body segments, which are stacked and/or arranged next to one another in a plane and connected to one another, made from a foamed thermoplastic plastics material, the structural element being completely made of thermoplastic plastics material and the body segments being welded to one another at their abutting faces with a formation of flat weld seams, comprising the following steps:
a. producing closed-cell foam bodies by an extrusion and foaming process or producing body segments by an extrusion and foaming process, followed by welding together the longitudinal sides of the body segments by flat partial melting of the side faces of the body segments which are to be connected and subsequent joining and rehardening to form foam bodies with the formation of flat weld seams, the flat weld seams being present as plastics material intermediate layers, which have few pores or are pore-free;
b. welding together the longitudinal sides of the foam bodies by flat partial melting of the side faces of the foam bodies which are to be connected and subsequent joining and rehardening to form a foam block with the formation of flat weld seams, the flat weld seams being present as plastics material intermediate layers which have few pores or are pore-free;
c. dividing the foam block into individual planar structural elements, transverse to the longitudinal direction of the foam bodies,
wherein the flat weld seams, in the plan view of the planar structural element, form a web structure with a reinforcing effect, wherein
the longitudinal sides of the foam bodies are partially melted by means of a heating blade with a structured surface with the production of groove-shaped indentations in the foam body, or wherein foam bodies which are structured by groove-shaped indentations on one or both sides are partially melted by means of a heating blade with an unstructured surface, or wherein unstructured foam bodies are firstly partially melted by means of a heating blade with an unstructured surface and then by means of a matrix providing a structure and the longitudinal sides of the foam bodies, which are partially melted in a further step, are joined with the formation of recesses in the weld seam.

14. A method for producing a planar structural element according to claim 13, wherein the longitudinal sides of the foam bodies are partially melted by means of a heating blade with a surface which is structured on one or both sides, with the production of groove-shaped indentations in the foam body.

15. A method for producing a planar structural element according to claim 14, wherein in each case the surfaces of the longitudinal sides of two foam bodies extending in the extrusion direction are heated on a heating blade until the surfaces of the longitudinal sides of the foam bodies soften or partially melt and the cells which are located on the surface collapse and form a thin skin of molten mass and one or both side faces of the heating blade have a structure, and the structure is impressed in the manner of a matrix into the thermoplastic plastics material, thereafter the foam bodies are separated from the heating blade and the heating blade is removed and the two heated surfaces of the longitudinal sides of the foam bodies are brought into mutual contact in the heated state, optionally with pressure loading, wherein the mutually contacting surfaces of the longitudinal sides are welded to one another and the thermoplastic plastics material hardens with cooling.

16. A method for producing a planar structural element according to claim 15, wherein the structure, which is present on one or both surfaces of the heating blade, is formed from a plurality of profile rods which are arranged at a spacing in parallel and extend over the entire height and the entire width of one or both surfaces of the heating blade.

17. A method for producing a planar structural element according to claim 16, wherein a lattice or waffle structure or a grid structure is formed on a structure, which is present on one or both surfaces of the heating blade, of crossing profile rods, and the obliquely or diagonally running profile rods run at any angle with respect to a side edge of the heating blade.

18. A method for producing a planar structural element according to claim 13, wherein the opposing longitudinal sides of two foam bodies, one or both of the longitudinal sides of the foam bodies being structured with grooves, channels or milled portions, are heated on a heating blade to such an extent that the surfaces of the foam bodies made of thermoplastic plastics material soften or partially melt and thereafter the heating blade is removed and the two structured heated surfaces of the foam bodies are brought into mutual contact, wherein the plastics material hardens with cooling.

19. A method for producing a planar structural element according to claim 13, wherein the opposing longitudinal sides of two foam bodies are heated on a heating blade, being a panel with two heated unstructured, smooth side faces, to such an extent that the heated surfaces of the foam bodies made of thermoplastic plastics material soften or partially melt and the heating blade is then removed and a comb-like matrix is introduced between the two heated surfaces of the foam bodies and the matrix and the foam bodies are brought into mutual contact, the plastics material being welded and hardened with cooling and the matrix then being guided out of the melting or softening zone of the two foam bodies.

20. A method for producing a planar structural element according to claim 13, wherein the longitudinal sides of the foam bodies are partially melted by means of a heating blade with a surface structured on one or both sides with the production of groove-shaped indentations in the foam body, a plurality of elongate indentations being let into one or both surfaces of the heating blade.

21. A combination comprising a planar structural element according to claim 1 and a structural component with an outer layer, wherein the outer layer is applied at least to one surface of the planar structural element.

22. A combination according to claim 21, wherein the planar structural element is the core or core layer in a structural component, wherein the structural component is a sandwich composite element, with outer layers arranged on both sides of the core or the core layer, or a composite component made of the core or core layer and outer layers.

23. A composite component comprising the sandwich composite element according to claim 20 as a core or core layer.
